(19) United States
(12) Patent Application Publication
(10) Pub. No.: US 2025/0129660 A1
(43) Pub. Date: Apr. 24, 2025

(54) SIDE SEALING

(71) Applicant: Assa Abloy Entrance Systems AB, Landskrona (SE)

(72) Inventor: Bert VAN DEN HAZEL, Putten (NL)

(21) Appl. No.: 18/722,204

(22) PCT Filed: Jan. 24, 2023
(86) PCT No.: PCT/EP2023/051637

§ 371 Date: Jun. 20, 2024

(30) Foreign Application Priority Data
Jan. 25, 2022 (SE) 2230021-4

(51) Int. Cl. E06B 7/23; E05F 15/668

(52) U.S. Cl. CPC E06B 7/2312; E05F 15/668; E05Y 2201/684; E05Y 2800/12

(57) ABSTRACT

A side sealing (100) is adapted to seal between a door blade (11) and a side frame (21) in an overhead door system. The side sealing (100) comprises a profile element (105). The profile element (105) comprises an attachment portion (120) adapted to be attached to one of the side frame (21) or door blade (11) and a sealing portion (110) adapted to come into sealing contact with the other of the side frame (21) or door blade (11). The profile element (105) is in a flexible material.

### TECHNICAL FIELD

Present invention relates to a side sealing adapted to seal between a door blade and a side frame in an overhead door system. Further, present invention relates to a side sealing kit and an overhead door system comprising such a side sealing. In addition, the present invention relates to a method for providing such a side sealing.

### BACKGROUND

Overhead doors systems are often utilized to selectively provide access for large objects, such as vehicles, to a building due to such door systems being able to seal off relatively large entrances at a comparatively low cost.

Overhead door systems generally comprise a door element which may be foldable by means of comprising a plurality of interconnected panels or a single panel in the form of a solid element. Such overhead door systems may be manually operated or automated by means of a motor and a belt arrangement or arm arrangement for forcing the movement of the door element.

To allow for the vertical movement of the door element the door system is provided with tracks for receiving wheels of a carrier attached to the door element. The tracks have both vertical and horizontal sections connected by a connecting section for guiding the movement of the door element from a vertical position, i.e. a closed position, and a horizontal position, i.e. an opened position.

Overhead door systems are associated with challenges in terms of insulation due to their design. In order to limit heat dissipation through the overhead door system and achieving a lower U-value, i.e. overall heat transfer coefficient, different sealing arrangements has been implemented into conventional overhead door systems. Commonly, side seals are provided to seal between the door and the door frame. Conventional side seals are available with different designs. Side seals runs along the height of the door on both sides of the door. The side seals are usually made of a rigid part and a soft part. The rigid part is intended to be attached to the side frame while the soft part is intended to come into contact with the door element when the door element is in the closed position. Usually, the rigid part is made of PCV and the soft part is in TPE or similar. The rigid part is required to be in a hard material to allow for attachment to the profile of the side frame.

Such a design is associated with a number of challenges. For example, PVC is sensitive to changes in temperature, and therefore, exposure to different weather conditions will lead to high environmental wear of the PVC, hence negatively affecting the performance of the side seal. Due to this maintenance and replacement of the side seal is required. However, transport of components of that length is costly and must be planned in advance. Typically, a long haul vehicle is needed to transport components with these lengths. The hassle and cost of transporting these components, usually leads to consumers avoiding this replacement, which renders the doors non-insulating towards outside environments. A solution practiced by some service personnel to overcome the transportation issue is to cut the side seal into several parts, transport it, and rejoin the parts together at site. However, cutting the seal jeopardizes the insulation and waterproof properties of the seal. Another issue with PVC is that it is associated with energy consuming manufacturing with a relatively high negative environmental impact.

In the light of the above, there is a need to provide an improved side sealing for an overhead door system.

### SUMMARY

According to an aspect, a side sealing is provided. The side sealing is adapted to seal between a door blade and a side frame in an overhead door system. The door blade is movable between a closed position and an opened position within said side frame. The side sealing comprises a profile element. The profile element comprises an attachment portion adapted to be attached to one of the side frame and the door blade. The profile element further comprises a sealing portion. The sealing portion is adapted to come into sealing contact with the other of the side frame or door blade. The profile element is in a flexible material.

According to an aspect, a side sealing kit is provided. The side sealing kit comprises one or more side sealing and a container. The container is adapted to contain the one or more side sealing.

According to an aspect, an overhead door system for covering a door opening in a wall is provided. The overhead door system comprises a door blade, the door blade is movable between a closed position and an opened position with said side frame. The overhead door system comprises one or more side sealing. Each of the one or more side sealing is provided along a vertical side of the door opening when the door blade is in the closed position to seal between the side frame and the door blade.

According to an aspect, a method for providing a side sealing adapted to seal between a door blade and a side frame in an overhead door system is provided. The door blade is movable between a closed position and an opened position within said side frame.

The method comprises providing a profile element of the side sealing in a flexible material and rolling said profile element relative a lengthwise direction of said profile element to form at least part of a roll.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

Objects, features and advantages of embodiments of the invention will appear from the following detailed description, reference being made to the accompanying drawings.

FIG. 1 illustrates an exemplary overhead door system comprising a side sealing according to one embodiment.

FIG. 2 illustrates a side sealing kit with a side sealing according to one embodiment.

FIG. 3 illustrates a side sealing according to an embodiment attached to a side frame of an overhead door system.

FIG. 4 illustrates a front view perspective of a side sealing according to one embodiment.

FIG. 5 schematically depicts a method for providing a side sealing according to one embodiment.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

Present invention relates to a side sealing and an overhead door system comprising such a side sealing.

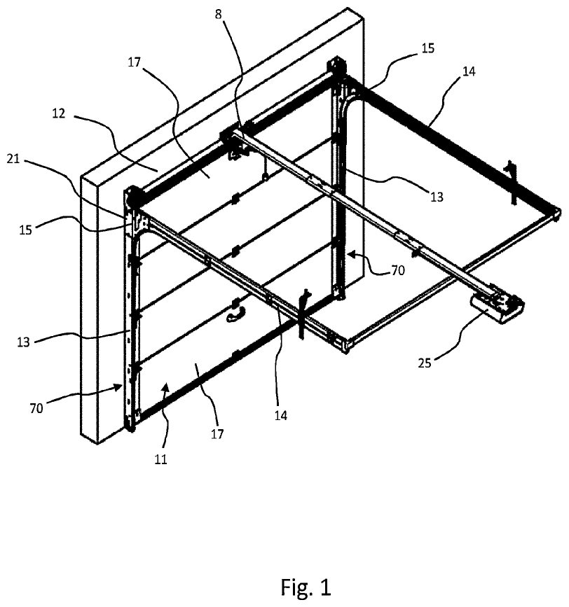

FIG. 1 shows a schematic front view of a first embodiment of an overhead door with the features of the invention in a closed state. The overhead door has a door blade 11 for covering a door opening in a wall 12, running in a side frame of said overhead door system. The door blade 11 is movable between a closed position and an opened position within the side frame 21. In the closed position, the door blade 11 covers the door opening. In the opened position, the door blade 11 is adapted to enable access through the door opening 12.

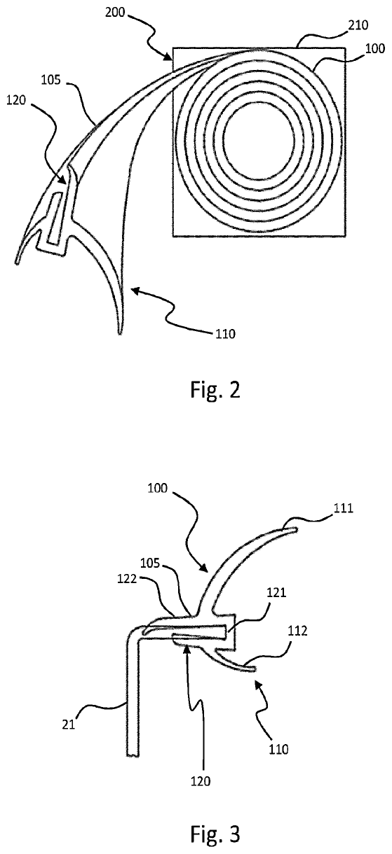

The overhead door system comprises one or more side sealing which will be further described with reference to FIGS. 2 to 4. Each of the one or more side sealing is provided along a vertical side of the door opening when the door blade 11 is in the closed position to seal between the side frame 21 and the door blade 11. A side sealing herein refers to a side sealing element. A side sealing according to the invention may thus be considered a side sealing element.

Preferably, the overhead door system comprises a first and second side sealing provided along a first and second vertical side of the door opening when the door blade 11 is in the closed position to seal between the side frame 21 and the door blade 11, respectively.

The side sealing may be attached to the side frame 21 or the door blade 11. In the case of the side sealing being attached to the door blade 11, the side sealing is movable relative the side frame 21 and is thus arranged to extend along the door blade 11 and along the vertical side of the door opening only when the door blade 11 is in the closed position. In the preferred embodiment however, the side sealing is attached to the side frame 21 and is thus stationary. Thus, the side sealing may be arranged on the side frame along the vertical side of the door opening.

As depicted, the side frame 21 may comprise a pair of vertical tracks 13 and a pair of horizontal tracks 14 connected by a pair connecting track portions 15. The opened position may thus be a horizontal or inclined opened position and the closed position may be a vertical closed position, i.e. a horizontal or inclined position of the door blade 11 and a vertical closed position of the door blade 11, respectively.

Accordingly, the door blade 11 covers a door opening surrounded double-sided by the side frame 21, the wall 12 and by a ceiling above. The side frame 21 has double-sided a vertical track 13, provided as a guiding element on the left and on the right side of the door blade 11, respectively. Further, the side frame has double-sided a horizontal track 14. The horizontal track 14 runs transversely, in this execution example perpendicular to the vertical track 13, extending rearward to the door blade 11. A connecting portion 15 with a curved shape connects the vertical track 13 and the horizontal track 14, providing a guideway 16. The horizontal tracks 14 of the side frame are fixed at a rear side under the ceiling. At a front side the horizontal tracks 14 are fixed at the vertical tracks 13 of the side frames, respectively. Accordingly, the overhead door system comprises a pair of vertical tracks 13 and a pair of horizontal tracks 14 connected by a pair of connecting track portions 15. Guiding arrangements 70 are attached to the door blade 11 for interfacing with the tracks. The guiding arrangements may comprise wheels or sliding members adapted to interface with the tracks of the side frame. The door blade 11 is movable between a vertical closed position and a horizontal, opened or overhead position within the side frame.

The side frame 21 may be comprised of a profile system. The profile system may comprise a plurality of profile elements interconnected to form said side frame 21. Preferably, the profiles are in metal such as steel or aluminum.

In one embodiment, the door blade 11 comprises a plurality of panels 17. The shown door blade 11 comprises four panels 17, consisting of a rigid material. To provide a better overview, reference signs are only attached to two panels 17. The height of the panels 17 may be between 150 and 1000 millimeters. The height of the panel may for example vary from 400 millimeters from 675 millimeters, making it possible to suit the door's style to that of the building. As the skilled person recognizes, the panels may be of any size suitable for the application of the overhead door system.

At least one of the panels 17 is connected to a driving member 8 connected to a motor 25 for operating the door blade 11 along the tracks. In one embodiment, one of the topmost panels 17 may be connected to the motor 22 by means of a lifting arm 8. Said lifting arm 8 is arranged to transfer the torque from the motor 25 to one of the panels 17 to pull and push the door blade along the tracks. With reference to FIG. 1, the lifting arm 8 is connected to the topmost panel 17.

In one embodiment, the driving member may be a driven belt. Accordingly, one belt connects end pieces of the panels 17 on both sides of the panels 17, respectively. Thereby the belt works as a lifting device and as a hinge between the panels 17. The belt runs in vertical direction in a slot 19 on both sides of the vertical track 13 of the side frame, respectively. The belts 20 may be constructed as flexible, flat belts. The motor 25 may be connected to a belt drive for operating the cable. The motor 25 may be connected to a gear box for transferring torque from the motor 25 to the belt drive.

In one embodiment, the driving member may be a cable, preferably in steel. The cable connects to at least one of the panels 17. Thereby the cable works as a lifting device. Further, one cable may connect end pieces of the panels 17 on both sides of the panels 17, respectively. The cable may run in vertical direction in a slot on both sides of the vertical track 13 of the side frame, respectively. The motor 25 may be connected to a cable drum for operating the cable. The motor 25 may be connected to a gear box for transferring torque from the motor 25 to the cable drum.

In one embodiment, the belt or cable may only be connected to the bottommost panel of the door blade 11. Hence, the door blade is lifted by means of the belt or cable working as a lifting device for lifting the bottommost panel of the door blade 11 and consequently lifting the entire door blade by means of the lifting force applied to said bottommost panel.

Turning to FIGS. 2 to 4, the side sealing according to the invention is depicted. The side sealing 100 is a side sealing adapted to seal between a door blade and a side frame in an overhead door system for example an overhead door system as depicted in FIG. 1. In the overhead door system, the door blade is movable between a closed position and an opened position within said side frame.

The side sealing 100 comprises a profile element 105. The profile element 105 may be considered an elongated profile element. The profile element 105 may extend a longitudinal axis. The side sealing 100 may extend along the longitudinal axis.

The profile element 105 comprises an attachment portion 120. The attachment portion 120 is adapted to be attached to one of the side frame and the door blade of the overhead door system. Thus, the side sealing may be attached to either one of the side frame and the door blade.

The profile element 105 comprises a sealing portion 110. The sealing portion 110 is adapted to come into sealing contact with the other of the side frame and the door blade. To clarify, the sealing portion 110 is adapted to come into sealing contact with the other of the side frame and the door blade when the door blade is in the closed position.

If the attachment portion 120 is adapted to be attached to the side frame, the sealing portion 110 may be adapted to come into sealing contact with the door blade 11 or vice versa. Sealing contact herein refers to the sealing portion 110 being adapted to deform upon coming into contact with the side frame or door blade to partially extend along said side frame or door blade when the door blade is in the closed position.

The profile element 105 may form the extension of the side sealing 100. The profile element 105 may thus extend along the length of the side sealing 100. The profile element 105 may be adapted to extend along the vertical side of the door opening when the door blade is in the closed position.

The sealing portion 110 and the attachment portion 120 extends along the profile element. The sealing portion 110 and the attachment portion 120 may in one embodiment form opposite longitudinal surfaces of the profile element 105.

Preferably, the profile element 105 is formed in one piece. The sealing portion 110 and the attachment portion 120 may thus be integrated into the same part. The sealing portion 110 and the attachment portion 120 may thus be integrally formed on the same part, i.e. the profile element 105.

In an alternative embodiment, the profile element may be constituted by interconnected sub-profiles, whereby said sub-profiles may comprise the attachment portion 120 and the sealing portion 110.

According to the invention, the profile element 105 is in a flexible material. The flexible material is a non-rigid material. The flexible material is adapted to be elastically deformable. The side sealing may thus be considered a flexible side sealing. The side sealing may be entirely in flexible material.

Conventional side sealings are typically in the form of two separate interconnected profiles. A first profile is in a rigid material and designed for attachment to the door blade or side frame. A second profile is in a soft and flexible material and designed for coming into sealing contact with the other of the door blade or side frame. The above described side sealing according to the invention comprises a profile element in a flexible material allowing for simple transportation since the profile element may be bent, folded or rolled etc. to fit more narrow spaces during transportation. The side sealing according to the invention further allows for an improved durability due to it being in a flexible material. Further, compared to having the attachment portion in a rigid material, the attachment portion according to the invention is less susceptible to wear and undesirable temperature effects.

Compared to bottom sealings of overhead door systems, side sealings are exposed to higher loads and are much more difficult to replace. Thus the requirements on side sealings are higher in terms of wear etc. For that reason, a side sealing is completely different in design both in terms of dimensions and attachment means.

The flexible material may comprise rubber. Any suitable type of rubber may be utilized, such as natural rubber, isoprene rubber, styrene-butadiene rubber, ethylene propylene diene monomer, nitrile rubber, butyl rubber and chloroprene rubber. The flexible material may also be a blend of materials providing similar functionality.

The profile element may be in rubber, such as natural rubber, isoprene rubber, styrene-butadiene rubber, ethylene propylene diene monomer, nitrile rubber, butyl rubber and chloroprene rubber.

Preferably, the profile element 105 is formed by extrusion. This allows for the profile to be achieved in a non-complex and cost-efficient manner.

The flexible profile element further allows for easy transportation of the side sealing. As depicted in FIG. 2, the profile element 105 may be rollable relative a lengthwise direction of the profile element 105. Thus, a side sealing allowing for particularly efficient transport is achieved. The profile element 105 is thus adapted to be rollable relative the lengthwise direction of said profile element to form a roll.

The profile element is thus adapted to be rolled about an axis extending orthogonal to the longitudinal axis. Accordingly, the profile element is adapted to be rolled about an axis orthogonal to the lengthwise direction of the profile element. The flexible material is thus adapted to enable rolling of the profile element and consequently the side sealing relative the lengthwise direction of the profile element.

Thus, the flexible material may be adapted to enable rolling of the profile element 105 relative its lengthwise direction. The rolled up profile element allows for a side sealing which is much easier to transport.

Further referencing FIG. 2, the side sealing 100 may be transported and provided as a part of a side sealing kit 200. The side sealing kit allows for easy transportation and mounting of one or more side sealing in an overhead door system.

The side sealing kit 200 comprises one or more side sealing 100 and a container 210. The side sealing 100 is adapted to contain the one or more side sealing 100. The side sealing 100 is contained in said container 210. In other words, the container is adapted to house said one or more side sealing. Due to the profile element 105 of the side sealing being in a flexible material the container may be of dimensions allowing for easy transportation.

Preferably, the profile element 105 of the one or more side sealing 100 is rolled up relative a lengthwise direction of said profile element 105 in said container 210. Accordingly, the roll at least partly formed by rolling of the profile element 105 relative its lengthwise direction is contained in said container 210. The container 210 is thus adapted to contain said roll. Thereby, optimal dimensions from a transporting and space efficiency point of view may be achieved. Accordingly, the profile element 105 of the one or more side sealing 100 may be arranged as a roll contained in the container 210.

Accordingly, the side sealing kit 200 may comprise the roll. The container 210 may be adapted to contain said roll. The roll is formed by the one or more side sealing 100. The roll is thus formed by the rolled up profile elements of the one or more side sealing. The roll may thus be formed by profile elements of the one or more side sealings provided in one piece, i.e. a single piece.

Advantageously, the side sealing kit may comprise at least two of said sealings as most commonly, an overhead door system is intended to have two side sealings. Thus, the container 210 may be adapted to contain said at least two side sealings. The pair of side sealings may be provided as separate rolls. Alternatively, the pair of side sealings may be provided as a single roll which may be cut before mounting to the overhead door system. Thus, the length of the roll may be chosen to form at least two side sealings.

Preferably, the roll is adapted to be cut to form the one or more side sealing and preferably two or more side sealings.

The container may have a height of between 30 and 70 mm and a width and depth between 0.3 and 0.8 meters. The container may be adapted to receive a profile element with a length of 3 to 12 meters. For example, a container with a height of 50 mm and a width and depth of about 0.5 and 0.7 m may be suitable to contain a roll with a profile element of about 10 meters. Preferably, the roll has a length of between 6 and 14 meters.

Preferably, the container 210, e.g. the inner wall of the container 210, is adapted to be in contact with the outer surface of the rolled up profile element 105 of the one or more side sealing 100 when said one or more side sealing 100 is contained in the container 210. The container 210 is thus adapted to be in contact with the roll. Thereby, the one or more side sealing is kept stable in the container during transportation.

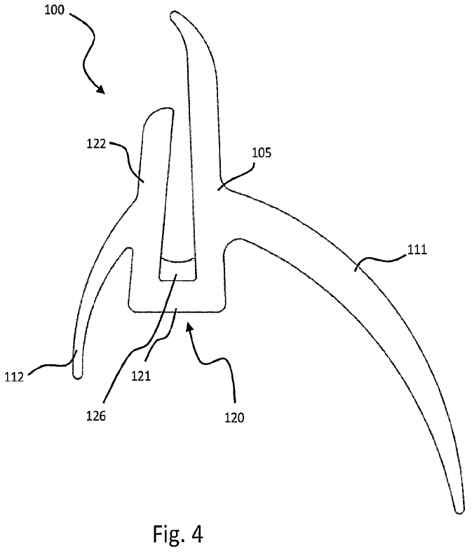

Preferably, the profile element is provided with an adhesive prior to being rolled. The adhesive will be further described with reference to FIG. 4.

According to an aspect, a side sealing roll may be provided. The side sealing roll comprises one or more side sealings. In one embodiment, the side sealing roll may comprise a plurality of side sealings and is adapted to be cut into a plurality of pieces, each of which forming a sealing element. The side sealing kit may comprise said sealing roll, whereby the container 210 may be adapted to contain said side sealing roll.

Referencing FIGS. 3 and 4, the sealing portion 110 may comprise one or more flaps 111, 112, i.e. sealing flaps. The one or more flaps 111, 112 are adapted to come into sealing contact with the side frame or door blade, i.e. when the door blade is in the closed position. The flaps 111, 112 are thus adapted to engage the side frame or door blade to seal against said side frame or door blade. In one embodiment in which the attachment portion is adapted to be attached to the side frame, the flaps are adapted to engage the door blade. In one embodiment in which the attachment portion is adapted to be attached to the door blade, the flaps are adapted to engage the side frame.

As depicted in FIGS. 2 to 4, the sealing portion 110 may comprise a first flap 111 and a second flap 112. The first flap 111 may be adapted to extend outwardly and horizontally towards the wall surrounding the opening. The second flap 112 may be adapted to extend inwardly and horizontally towards the vertical center of the opening.

Preferably, the first flap 111 may be wider than the second flap 112. Accordingly, the first flap 111 may protrude a longer distance from the longitudinal axis along which the profile element extends compared to the second flap 112. This is particularly advantageous due to second flap sealing providing the outer sealing around the door which is more susceptible to heat transfer and water passage.

The first and/or second flap 111, 112 may be provided with a curvature to accommodate the desired deformation when coming into contact with the door blade or side frame. It should be recognized that the flaps may be dimensioned or designed in multiple ways, each being readily available for the skilled person.

Referencing FIG. 3, the connection provided by the attachment portion is depicted in further detail. The attachment portion 120 is adapted to be attached to the side frame or the door blade via a clamping fit or engagement. The attachment portion 120 may thus be adapted to be attached to side frame or door blade by means of a clamping fit or engagement. The attachment portion 120 may thus be provided with attachment means adapted to provide a clamping fit with corresponding attachment means provided on the door blade or side frame.

In one embodiment, the attachment portion 120 comprises a clamping member 122. The clamping member 122 is adapted to be clamped onto the side frame or the door blade. The clamping member 122 may be adapted to be clamped onto a corresponding clamping flange on a profile of the side frame or the door blade.

In order to ensure proper attachment even for sectional door blades (door blades with interconnected panels), the side sealing 100 is preferably attached to the side frame 21. Hence, the side sealing 100 may be adapted to be attached to the side frame 21. The attachment portion 120 may accordingly comprise a clamping member 122 adapted to be clamped onto the side frame 21. The clamping member 122 may be a retaining element with a recess 121 adapted to receive a flange of the side frame 21 to retain said retaining element onto the side frame.

One advantage of having a clamping member 122 being a retaining element with a recess 121 may be that the side sealing 100 may be suitable to be used with various profiles of the side frame or the door blade, having different shapes.

In one embodiment, the side sealing 100 is adapted to be attached to the vertical track of the side frame. Preferably, a first side sealing is attached to a first vertical track of the side frame and a second side sealing is attached to a second vertical track of the side frame in the overhead door system.

FIG. 4 depicts the side sealing 100 in further detail. To ensure attachment to the side frame or door blade an adhesive is utilized. Thus, the side sealing 100 may comprise an adhesive 126. The adhesive 126 is provided on the attachment portion 120 for adhesion of the profile element 105 to the side frame 21 or the door blade 11. The adhesive is of particular importance to compensate for the retaining properties of the flexible material in the attachment portion being weaker compared to an attachment portion in a conventional rigid material.

The positioning and amount of adhesive may be adapted depending on the design of the side frame or door blade on which the attachment portion is to be attached. The side sealing may be adapted to be solely attached to the door blade or side frame by means of said adhesive and the retaining connection between the attachment portion and said door blade or side frame.

Preferably, the adhesive 126 is adapted to provide a releasable attachment of the profile element 105 to the side frame 21 or the door blade 11. Accordingly, the adhesive 126 is adapted to provide a releasable adhesion between the profile element 105 and the side frame or door blade. The adhesive 126 may be adapted to provide a releasable adhesion of the profile element 105 to the side frame or the door blade. Thus, the adhesive 126 is adapted to allow for manual detachment of said profile element 105 from said door blade or side frame.

Such an adhesive enables easy removal of the side sealing simply by means of manually ripping the profile element of the door blade or side frame. In conventional side sealings, the rigidity of the profile attached to the door blade or side frame makes it cumbersome and difficult to remove due to the large clamping forces between the door blade or side frame and the profile. It may also require loosening of the bolts of the side frame or door blade to allow for the release of the side sealing.

Preferably, the adhesive 126 is provided as a strip extending along the profile element 105. The adhesive 126 is in itself flexible to allow for rolling of the profile element. Accordingly, the side sealing may be constituted by the adhesive and the profile element each being in a flexible material.

Preferably, the adhesive 126 is a hot melt sealant. Preferably, the adhesive 126 is a butyl sealant. Such an adhesive allows for applying of the sealant well before mounting due to it not drying out for a long period of time. Thus it allows for an easier installation of the side sealing. Such a butyl sealant provides a releasable attachment of the profile element to the side frame or the door blade.

Advantageously, the adhesive 126 is adapted to extend in the clamping fit or engagement between the attachment portion 120 and the side frame or the door blade. Thus, the adhesive is protected upon attachment of the side sealing to the door blade or side frame. Accordingly, the adhesive 126 is arranged to extend in the clamping fit or engagement between the attachment portion and the side frame or the door blade when the side sealing 100 is attached to said side frame or door blade. In the depicted embodiment, the adhesive is arranged in the recess 121 of the retaining element 122.

Further referencing FIG. 4, the flaps 111, 112 may each protrude from the retaining element 122. The first flap 111 connects to a first longitudinal surface of the retaining element 122. The second flap 112 connects to a second longitudinal surface of the retaining element 122. The second longitudinal surface is opposite to the first. The first and second longitudinal surface may be formed on a first and second clamping flange of the retaining element 122, respectively. The retaining element 122 may be in the form of a U-member. The U-member may be comprised of the first and second clamping flange and an interconnecting part connecting said first and second clamping flange. The adhesive 121 may be provided in the recess 122 of the U-member, i.e. on the interconnecting part between the first and second clamping flange.

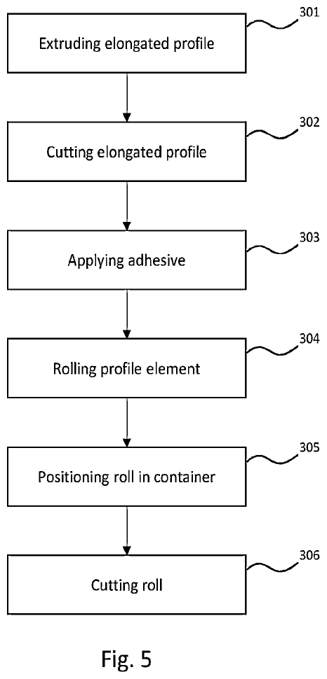

According to an aspect a method for providing a side sealing 100 is provided. The side sealing 100 is adapted to seal between a door blade and a side frame in an overhead door system. The door blade is movable between a closed position and an opened position within said side frame. The side sealing 100 may be the side sealing described with reference to FIGS. 1 to 4. The method is schematically depicted in FIG. 5.

The method may comprise providing a profile element 105 of the side sealing 100 in a flexible material. Further, the method may comprise rolling said profile element 105 relative a lengthwise direction of said profile element 105 to form at least part of a roll. In one embodiment, the profile element 105 may be provided together with additional profile elements in a single piece. The profile elements are rolled together to together form said roll.

In one embodiment, the method may further comprise extruding the profile element 105. The profile element may be extruded as a part of an elongated profile In one embodiment, the profile element 105 comprises the attachment portion 120. The attachment portion 120 is adapted to be attached to one of the side frame and door blade. The profile element 105 further comprises the sealing portion 105. The sealing portion is adapted to come into sealing contact with the other of the side frame and the door blade. According to such an embodiment, the method may further comprise applying the adhesive 126 on the attachment portion 120 for adhesion of the profile element 105 to the side frame or the door blade.

In one embodiment, the method further comprises cutting the elongated profile to a desired length to form the roll.

In one embodiment, the roll may have a length suitable for forming a plurality of profile elements, e.g. side sealings. Thus, the method may further comprise cutting the roll to form the side sealing.

In one embodiment, the method further comprises providing the container 210 and positioning the rolled-up profile element, i.e. the roll, in said container 210. The roll may be positioned in said container 210 such that said container encapsulates said roll. The container 210 being adapted to contain or house said roll.

To exemplify, in a first step 301, an elongated profile in a flexible material is extruded. As aforementioned, the elongated profile may be in rubber or at least comprise rubber.

In a second step 302, said elongated profile is cut, e.g. cut to a desired length to form the roll. The desired length of the roll is chosen based on the dimensions of the overhead door system.

In a third step 303, the adhesive 126 is applied on the attachment portion of the profile element 105. As aforementioned, the adhesive may be provided as a strip of butyl sealant.

In a fourth step 304, the profile element 105 is rolled relative its lengthwise direction to form a roll. The entire cut elongated profile is thus rolled relative its lengthwise direction to form the roll.

In a fifth step 305, the roll is positioned in the container 210.

In a sixth step 306, the roll is cut to form the side sealing 100 and the profile element 105. The roll is cut according to the dimensions of the overhead door system. Preferably, the cutting may be performed just prior to attachment of the side sealing to the side frame or door blade. For example, service personnel may have a container with a roll available in a service vehicle when servicing the door. If the side sealing needs to be replaced, the roll may be cut to form a side sealing according to the dimensions of the overhead door system and thereafter attached to the door. Accordingly, the method may further comprise taking the roll from the container, cutting said roll and attaching the obtained side sealing to the side frame or door blade of the overhead door system.

The invention has been described above in detail with reference to embodiments thereof. However, as is readily understood by those skilled in the art, other embodiments are equally possible within the scope of the present invention, as defined by the appended claims.

1. Side sealing (100) adapted to seal between a door blade (11) and a side frame (21) in an overhead door system, the door blade (11) being movable between a closed position and an opened position within said side frame (21),
the side sealing (100) comprising:
a profile element (105) comprising an attachment portion (120) adapted to be attached to one of the side frame (21) and the door blade (11) and a sealing portion (110) adapted to come into sealing contact with the other of the side frame (21) or door blade (11), wherein the profile element (105) is in a flexible material.

2. Side sealing (100) according to claim 1, wherein the sealing portion (110) comprises one or more flaps (111, 112) adapted to engage the side frame (21) or door blade (11) to seal against said side frame (21) or door blade (11).

3. Side sealing (100) according to claim 1, wherein the attachment portion (120) is adapted to be attached to the side frame (21) or the door blade (11) via a clamping engagement.

4. Side sealing (100) according to claim 3, wherein the attachment portion (120) comprises a clamping member (122) adapted to be clamped onto the side frame (21) or the door blade (11).

5. Side sealing (100) according to claim 1, wherein the profile element (105) is rollable relative a lengthwise direction of said profile element (105).

6. Side sealing (100) according to claim 1, wherein the flexible material comprises rubber and in particular any one of natural rubber, isoprene rubber, styrene-butadiene rubber, ethylene propylene diene monomer, nitrile rubber, butyl rubber and chloroprene rubber.

7. Side sealing (100) according to claim 1, wherein the profile element (105) is formed by extrusion.

8. Side sealing (100) according any one of the preceding claims to claim 1, further comprising an adhesive (126) provided on the attachment portion (120) for adhesion of the profile element (105) to the side frame (21) or the door blade (11).

9. Side sealing (100) according to claim 8, wherein the adhesive (126) is adapted to provide a releasable adhesion of the profile element (105) to the side frame (21) or the door blade (11).

10. Side sealing (100) according to claim 8, wherein the adhesive (126) is provided as a strip extending along the profile element (105).

11. Side sealing (100) according to claim 8, wherein the adhesive (126) is a hot melt sealant.

12. Side sealing (100) according to claim 8, wherein the adhesive (126) is a butyl sealant.

13. Side sealing (100) according to claim 8, wherein the adhesive (126) is arranged to extend in a clamping engagement between the attachment portion (120) and the side frame (21) or the door blade (11) when the side sealing (100) is attached to said side frame (21) or door blade (11).

14. A side sealing kit (200) comprising one or more side sealing (100) according to claim 1 and a container (210), the container (210) being adapted to contain said one or more side sealing (100).

15. The side sealing kit (200) according to claim 14, wherein the profile element (105) of the one or more side sealing (100) is rolled up relative a lengthwise direction of said profile element (105) in said container (210).

16. The side sealing kit (200) according to claim 15, further comprising a roll, the container (210) being adapted to contain said roll, the roll being formed by the one or more side sealing (100).

17. The side sealing kit (200) according to claim 14, comprising at least two side sealings (100), the container (210) being adapted to contain said at least two side sealings (100).

18. The side sealing kit (200) according to according to claim 16, wherein the roll is adapted to be cut to form said one or more side sealing (100) and preferably two or more side sealings (100).

19. The side sealing kit (200) according to claim 16, wherein the roll has a length of between 6 and 14 meters.

20. An overhead door system for covering a door opening in a wall (12), the overhead door system comprising a door blade (11), the door blade (11) being movable between a closed position and an opened position within a side frame (21), wherein the overhead door system comprises one or more side sealing (100) according to claim 1, wherein each of said one or more side sealing is provided along a vertical side of the door opening when the door blade (11) is in the closed position to seal between the side frame (21) and the door blade (11).

21. The overhead door system according to claim 20, wherein the side sealing (100) is attached to the side frame (21).

22. The overhead door system according to claim 20, wherein the side frame (21) comprises a pair of vertical tracks (13) and a pair of horizontal tracks (14), connected by a pair of connecting track portions (15).

23. The overhead door system according to claim 20, comprising a first and second side sealing (100) each being provided along a first and second vertical side of the door opening when the door blade (11) is in the closed position to seal between the side frame (21) and the door blade (11), respectively.

24. Method for providing a side sealing (100) adapted to seal between a door blade (11) and a side frame (21) in an overhead door system, the door blade (11) being movable between a closed position and an opened position within said side frame (21), the method comprising:
providing a profile element (105) of the side sealing (100) in a flexible material, and
rolling said profile element (105) relative a lengthwise direction of said profile element (105) to form at least a part of a roll.

25. Method according to claim 24, further comprising extruding the profile element (105).

26. Method according to claim 24, wherein the profile element (105) comprises an attachment portion (120) adapted to be attached to one of the side frame (21) and door blade (11) and a sealing portion (100) adapted to come into sealing contact with the other of the side frame (21) and the door blade (11).

27. Method according to claim 26, further comprising applying an adhesive (126) on the attachment portion (120) for adhesion of the profile element (105) to the side frame (21) or door blade (11).

28. Method according to claim 24, further comprising cutting the roll to form the side sealing (100).

29. Method according to claim 24, further comprising providing a container (210) and positioning the roll in said container (210).
